(19) United States
(12) Patent Application Publication
(10) Pub. No.: US 2018/0065215 A1
(43) Pub. Date: Mar. 8, 2018

(54) DRIVING SLEEVE IN A TOOL RECEIVING DEVICE

(71) Applicant: Hilti Aktiengesellschaft, Schaan (LI)

(72) Inventors: Rainer Kussmaul, Utting a, Ammersee (DE); Manfred Schallert, Nenzing (AT); Frank Mueller, Pforzheim (DE)

(21) Appl. No.: 15/556,938

(22) PCT Filed: Mar. 10, 2016
(86) PCT No.: PCT/EP2016/055112

§ 371 Date: Sep. 8, 2017

(30) Foreign Application Priority Data
Mar. 10, 2015 (EP) 15158348.1

(51) Int. Cl. B23P 11/00; B25D 17/08

(52) U.S. Cl. CPC B23P 11/005; B25D 2217/0034; B25D 2217/0003; B25D 17/084

(57) ABSTRACT

A method for the production of a tool receiving device is disclosed. The method includes positioning at least one sleeve with at least one driving web on an outer circumferential surface of at least one component of a forming tool, inserting the at least one component of the forming tool into a cylindrical bore of the tool receiving device such that an outer circumferential surface of the sleeve bears on an inner circumferential surface of the tool receiving device, and exerting a force on the outer circumferential surface of the tool receiving device for forming the tool receiving device and for forming at least a partial region of the inner circumferential surface of the tool receiving device, on which bears the outer circumferential surface of the sleeve, so that a non-positive and positive locking connection is produced between the inner circumferential surface of the tool receiving device and the sleeve.

This application claims the priority of International Application No. PCT/EP2016/055112, filed Mar. 10, 2016, and European Patent Document No. 15158348.1, filed Mar. 10, 2015, the disclosures of which are expressly incorporated by reference herein.

### BACKGROUND AND SUMMARY OF THE INVENTION

The present invention relates to a method for the manufacture of a tool receiving device, preferably for a jackhammer, chisel hammer or combination hammer, as well as to the arrangement of driving webs on the tool receiving device.

Power tools, such as, for example, jackhammers, chisel hammers or combination hammers, usually contain a cylindrically designed tool receiving device into which one end of a tool (for example a chisel) is received and held. In order to enable a rotary entrainment of the tool in the tool receiving device, a number of so-called driving webs are provided on the inside of the tool receiving device. The driving webs are in this case usually designed as projections on the inner surface of the tool receiving device and engage into correspondingly formed depressions on the tool. The tool receiving device is normally made from a first material and the driving webs are made from a second essentially harder material. The driving webs are hereby more wear-resistant.

The manufacture of such a tool receiving device with corresponding driving webs is, however, complex and costly since both a substantially cylindrical base body has to be formed into the actual shape of the tool receiving device and the driving webs have to be brought to the corresponding positions on the inside of the tool receiving device.

The object of the present invention is thus to provide a method for manufacturing a tool receiving device, preferably for a jackhammer, a chisel hammer or a combination hammer, as well as to the arrangement of driving webs on the tool receiving device by means of which the aforementioned problem is solved and in particular a tool receiving device with corresponding driving webs can be designed more simply, efficiently and cost-effectively.

For this purpose, a method is provided for manufacturing a tool receiving device, preferably for a jackhammer, a chisel hammer or a combination hammer as well as to the arrangement of driving webs on the tool receiving device.

According to the invention, the following method steps are in this case provided:
positioning at least one sleeve with at least one driving web on the outer circumference surface of at least one component of a forming tool;
inserting the at least one component of the forming tool into a cylindrical bore of the tool receiving device so that an outer surface of the sleeve bears on an inner circumferential surface of the tool receiving device, and
exerting a force on the outer circumferential surface of the tool receiving device for forming the tool receiving device and, in particular for forming of at least a partial region of the inner circumferential surface of the tool receiving device on which the outer surface of the sleeve bears so that a non-positive and positive locking connection is produced between the inner circumferential surface of the tool receiving device and the sleeve.

According to one advantageous embodiment of the present invention, a heat treatment can in this case be provided at least on the non-positive and positive locking connection between the inner circumferential surface of the tool receiving device and the sleeve. The mechanical strength of the driving webs can be hereby further increased on the inner circumferential surface of the tool receiving device.

Additional advantages emerge from the following description of the figures. Different exemplary embodiments of the present invention are illustrated in the figures. The figures, the description and the claims contain numerous features in combination. The person skilled in the art will expediently also consider the features individually and combine them to form appropriate additional combinations.

Identical and similar components are labelled in the figures with the same reference numerals.

### BRIEF DESCRIPTION OF THE DRAWINGS

FIG. 1 is a schematic side view of a power tool with a tool receiving device and tool;

FIG. 2 is a perspective view of the tool receiving device and the tool in a non-connected state;

FIG. 3 is a front view of the tool receiving device and the tool;

FIG. 4 is a sectional view along a side view of a tool receiving device and a forming tool including sleeve with driving webs in a non-connected state;

FIG. 5 is a first side sectional view of a forming tool with a two-part mandrel;

FIG. 6 is a second side sectional view of the forming tool with sleeve positioned on the forming tool with driving webs;

FIG. 7 is a sectional view along a front end of the tool receiving device and the forming tool including sleeve with driving webs in a non-connected state;

FIG. 8 is a sectional view along the side view of the tool receiving device and the forming tool including sleeve with driving webs in a connected state;

FIG. 9 is a sectional view along the front end of the tool receiving device and the forming tool including sleeve with driving webs in a connected state; and

FIG. 10 is a sectional view of a detail of the tool receiving device and the sleeve in a connected state.

### DETAILED DESCRIPTION OF THE DRAWINGS

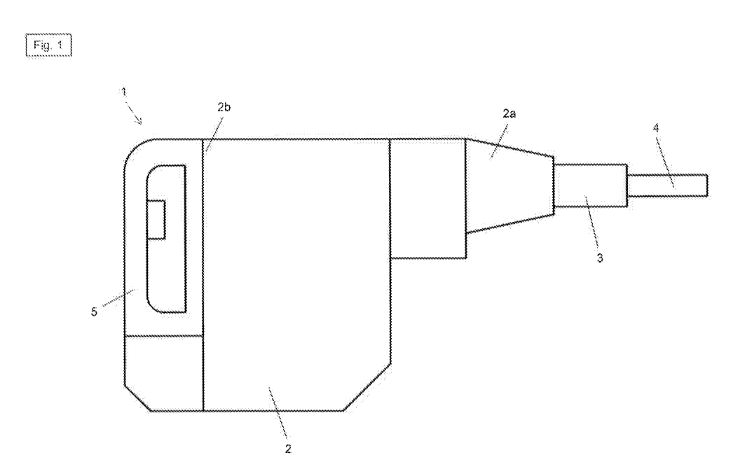

FIG. 1 shows a power tool 1 in the form of a jackhammer. However, the power tool 1 can also be implemented in any other suitable form such as, for example, a chisel hammer or combination hammer.

The power tool 1 contains substantially a housing 2, a tool receiving device 3 and a tool 4. The tool receiving device 3 is used to transfer a torque produced in the power tool 1 and vibration-like impacts (i.e., movement in the axial direction) to the tool. By means of this transfer, a correspondingly suitable material (e.g., mineral rock) can be processed using the tool 4.

The tool 4 can for example be a chisel or similar. The housing 2 has a front end 2a and a rear end 2b. The tool receiving device 3 for receiving a tool 4 is positioned on the front end 2a. A handgrip 5 for holding and guiding the power tool 1 is in turn arranged on the rear end 2b.

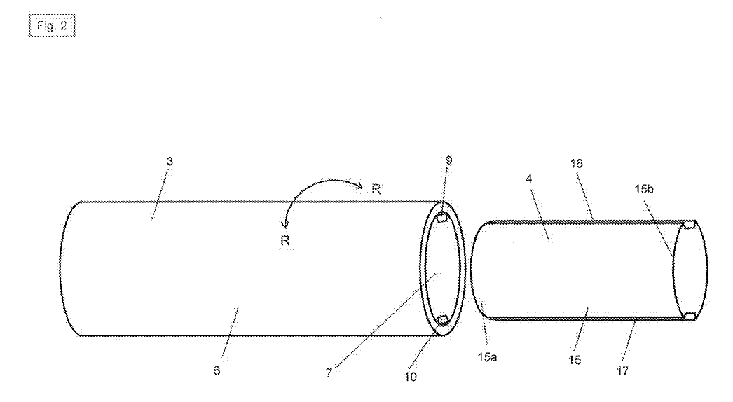

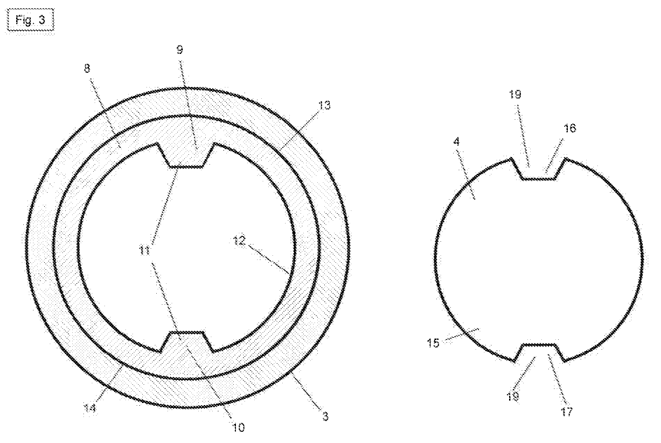

As is particularly illustrated in FIGS. 2 and 3, the tool receiving device 3 substantially contains a cylindrical base body 6 with a cylindrical bore 7. The cylindrical bore 7 in turn contains a cylindrical sleeve 8 with a first driving web 9 and a second driving web 10.

The first driving web 9 and the second driving web 10 respectively have a cross-sectional surface 11 in the form of an isosceles trapezoid and are positioned in an opposing manner on the inner circumferential surface 12 of the sleeve 8. However, it is also possible for the cross-sectional surface 11 of the first and second driving web 9, 10 to have any other form. The sleeve 8 is arranged with the outer circumferential surface 13 on the inner circumferential surface 14 of the base body 6 of the tool receiving device 3.

According to an alternative embodiment, more or fewer than two driving webs 9, 10 can also be provided on the sleeve 8. In this case, it is not necessary for two driving webs 9, 10 to be respectively positioned in an opposing manner on the inner circumferential surface 12 of the sleeve 8. It must be noted that the material of the sleeve 8 and the driving webs 9, 10 is substantially harder than the material of the base body 6 of the tool receiving device 3.

As is also illustrated in FIGS. 2 and 3, the tool 4 substantially contains a cylindrical base form 15 with a first end 15a and a second end 15b. The tool 4 can be inserted into the cylindrical bore 7 of the tool receiving device 3 with the first end 15a. The tool 4 is illustrated in FIGS. 1 and 2 without corresponding blades for processing a material on the second end 15b. The tool 4 designed as a chisel contains a first depression 16 and a second depression 17, and the two depressions 16, 17 are arranged in an opposing manner on the outer circumferential surface of the cylindrical base form 15. The first and second depression 16, 17 respectively have one cross-sectional surface 19 in the form of an isosceles trapezoid. However, it is also possible for the cross-sectional surface 19 of the first and second depression 16, 17 to have any other suitable shape. However, the cross-sectional surface 19 of the first and second depression 16, 17 in this case has to correspond to the cross-sectional surface 11 of the first and second driving web 9, 10.

In order that the torque produced in the power tool 1 and the vibration-like impacts can be transferred to the tool 4, the tool 4 designed as a chisel is inserted with the first end 15a of the base shape 15 into the cylindrical bore 7 of the tool receiving device 3. Owing to the positive-locking connection of the driving webs 9, 10 of the tool 4 with the corresponding depressions 16, 17 of the tool receiving device 3, the tool 4 and the tool receiving device 3 cannot be rotated relative to each other in the direction R or R′. A torque can be hereby transferred from the tool receiving device 3 to the tool 4.

The method for manufacturing a tool receiving device 3 according to the invention, preferably for a jackhammer, chisel hammer or combination hammer and to the arrangement of the sleeve 8 with the driving webs 9, 10 on the tool receiving device 3 is described below.

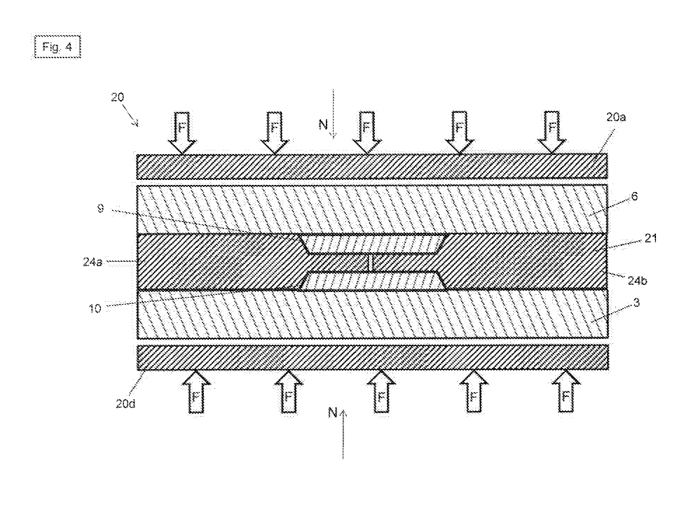

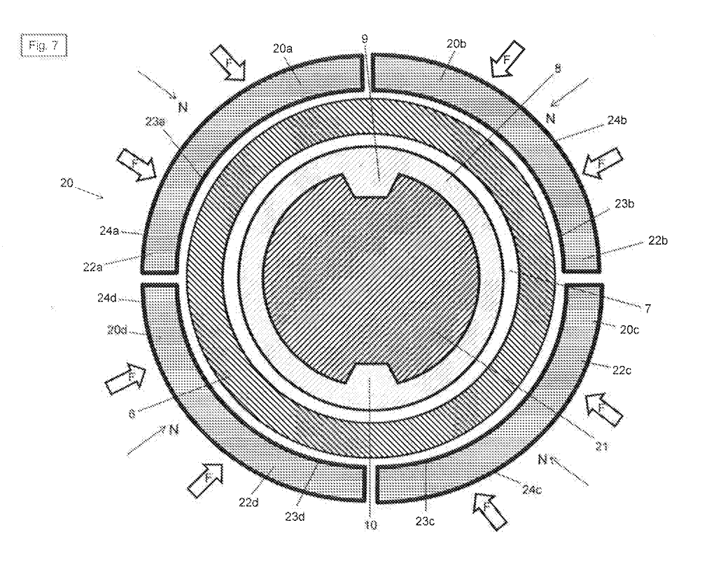

As illustrated in FIGS. 4 and 7, the sleeve 8 with the two driving webs 9, 10 is fastened to the inner circumferential surface 14 of the base body 6 of the tool receiving device 3 with the aid of a forming tool 20. It should be noted that the complete forming tool 20 is not illustrated in the figures and only some of the most important components are schematically illustrated.

The forming tool 20 in this case contains a first, second, third and fourth forming shell 20a, 20b, 20c, 20d (see FIG. 7). The four forming shells 20a, 20b, 20c, 20d are in this case positioned around a central mandrel 21. Each of the four forming shells 20a, 20b, 20c, 20d has a curved base form 22a, 22b, 22c, 22d with a concave surface 23a, 23b, 23c, 23d and convex surface 24a, 24b, 24c, 24d. The four forming shells 20a, 20b, 20c, 20d are arranged around the central mandrel 21 such that the concave surface 23a, 23b, 23c, 23d of each forming shell 20a, 20b, 20c, 20d is directed towards the mandrel 21.

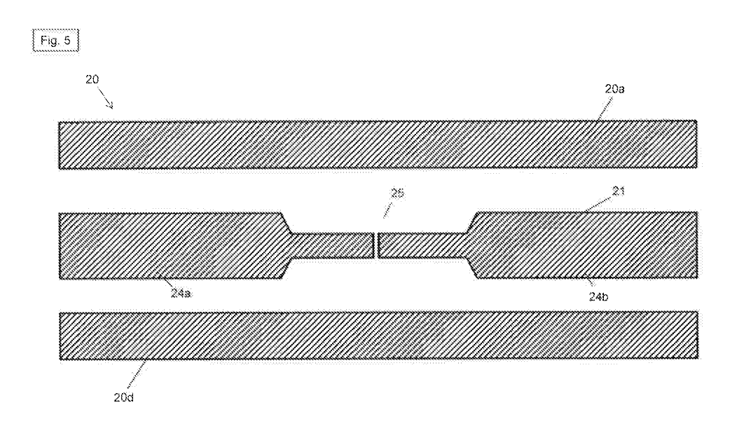

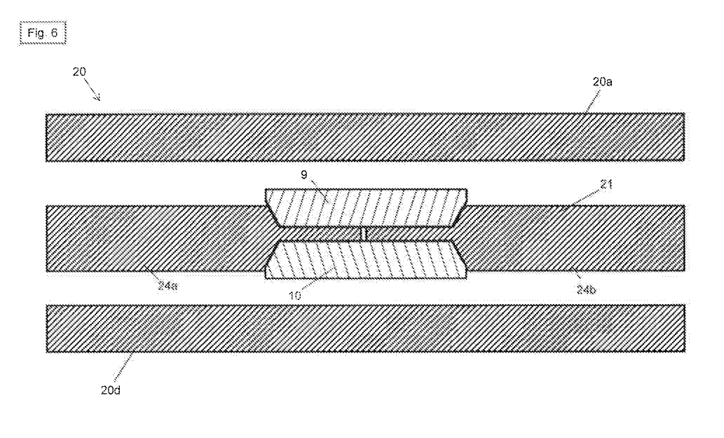

The central mandrel 21 substantially contains a cylindrical two-part base body 24 which contains a first base body part 24a and a second base body part 24b. The base body 24 also contains a recess 25 surrounding the base body 24 (see FIG. 5). The recess 25 substantially corresponds to the shape of the sleeve 8 and serves to receive the sleeve 8 with the driving webs 9, 10. However, the shape of the recess 25 is in this case selected such that the sleeve 8 protrudes from the recess 25 to a certain extent (see FIGS. 6 and 7).

The forming tool 20 substantially has a first position and a second position and can be moved reversibly between the first and the second position.

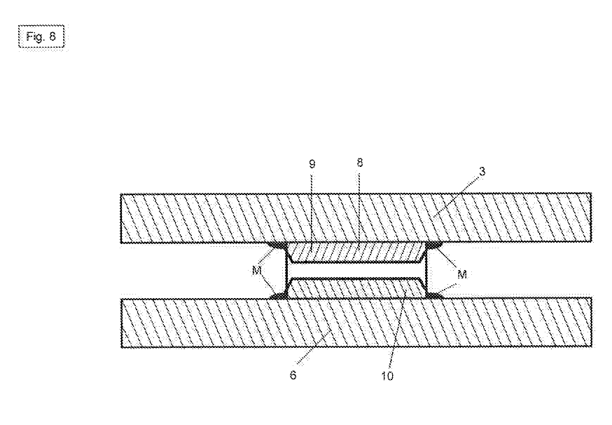

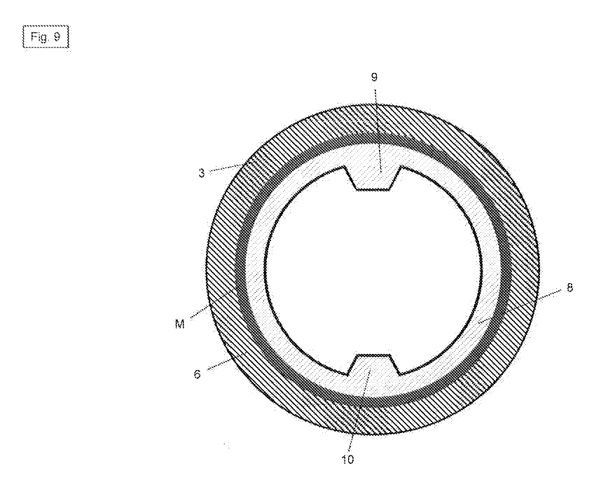

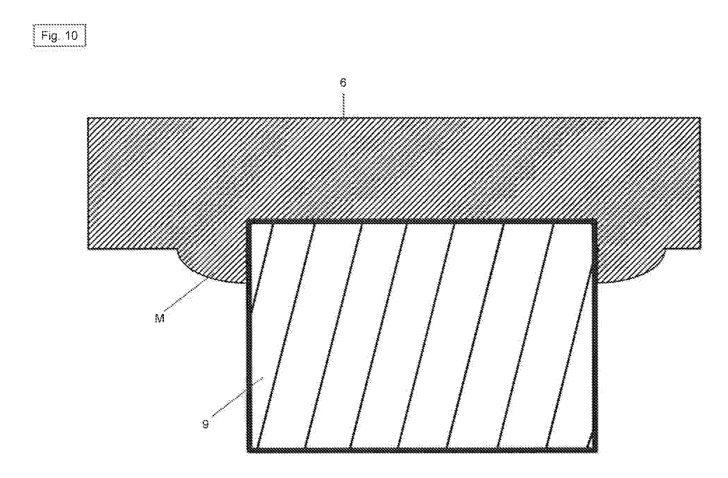

In the first position, the forming tool 20 is open, i.e., the four forming shells 20a, 20b, 20c, 20d are moved away from the mandrel 21 such that a certain distance results between the individual forming shells 20a, 20b, 20c, 20d and the mandrel 21 (see FIGS. 4 and 7). The cylindrical base body 6 of the tool receiving device 3 can be positioned in the distance between the individual forming shells 20a, 20b, 20c, 20d and the mandrel 21. The forming tool 20 is closed in the second position i.e., each forming shell 20a, 20b, 20c, 20d is moved towards the mandrel 21 in the corresponding direction N such that the tool receiving device 3 is held fixed between the mandrel 21 and the individual forming shells 20a, 20b, 20c, 20d. Pressure F is exerted externally on the individual forming shells 20a, 20b, 20c, 20d so that the material of the base body 6 of the tool receiving device 3 is adapted to the shape of the mandrel 21 and the forming shells 20a, 20b, 20c, 20d. As both the material of the sleeve 8 with the driving webs 9, 10 and the material of the mandrel 21 and the forming shells 20a, 20b, 20c, 20d is substantially harder than the material of the base body 6 of the tool receiving device 3, the sleeve 8 protruding from the recesses 25 of the mandrel 21 is pressed or kneaded into the inner circumferential surface 14 of the base body 6 of the tool receiving device 3. The sleeve 8 penetrates into the base body 6 such that material is pressed or kneaded from the base body 6 over the corners of the sleeve 8. A material wrap M develops over the ends of the sleeve 8 whereby the sleeve 8 with the driving webs 9, 10 is fixedly connected to the inner circumferential surface 14 of the base body 6 (see FIGS. 8, 9, 10). After the sleeve 8 has been kneaded on the inner circumferential surface 14 of the base body 6, the forming tool 20 is moved from the second position into the first position such that the forming shells 20a, 20b, 20c, 20d are moved away from the mandrel 21 and the tool receiving device 3 is uncovered again.

The sleeve 8 with the driving webs 9, 10 in this case remains on the inner circumferential surface 14 of the base body 6. The mandrel 21 can be removed from both ends from the sleeve 8 owing to the two-part design of the mandrel.

In addition to the previously described method steps, a heat treatment can still follow after the pressure has finished being exerted by the forming tool 20 on the tool receiving device 3. Heat is hereby targetedly directed on the points of the inner circumferential surface 14 of the base body 6 at which the sleeve 8 is connected to the base body 6. The mechanical strength of the sleeve 8 with the driving webs 9, 10 on the inner circumferential surface 14 of the base body 6 of the tool receiving device 3 can be further increased by the heat treatment.

1.-2. (canceled)

3. A method for manufacturing a tool receiving device, comprising the steps of:
positioning a sleeve with a driving web on an outer circumferential surface of a component of a forming tool;
inserting the component of the forming tool into a cylindrical bore of the tool receiving device so that an outer circumferential surface of the sleeve bears on an inner circumferential surface of the tool receiving device; and
exerting a force on the outer circumferential surface of the tool receiving device for forming the tool receiving device and for forming of at least a partial region of the inner circumferential surface of the tool receiving device on which the outer circumferential surface of the sleeve bears so that a non-positive and a positive locking connection is produced between the inner circumferential surface of the tool receiving device and the sleeve.

4. The method according to claim 3, further comprising the step of providing a heat treatment on the non-positive and the positive locking connection.
